(19) United States
(12) Patent Application Publication
(10) Pub. No.: US 2017/0363498 A1
(43) Pub. Date: Dec. 21, 2017

(54) DUNNAGE DEVICE AND SYSTEM

(71) Applicant: Sencentric, Inc., Carlsbad, CA (US)

(72) Inventors: Joseph Alfrey, Carlsbad, CA (US); Mark Hopperton, Ramona, CA (US)

(21) Appl. No.: 15/626,630

(22) Filed: Jun. 19, 2017

Related U.S. Application Data
(60) Provisional application No. 62/351,870, filed on Jun. 17, 2016.

(51) Int. Cl. G01L 19/08; B65D 81/05

(52) U.S. Cl. CPC G01L 19/086; B65D 81/052

(57) ABSTRACT

An apparatus, method and system are provided which permit the monitoring of a dunnage bag used as a cushion in the transportation of cargo items which may be typically found in as shipping container. A gas pressure sensor may be attached directly to the dunnage bag and the pressure can be monitored remotely. The gas pressure sensor can also be enclosed within a sealed and pressurized enclosure whereby the gas sensor reading can serve as indication of pressure of a nearby dunnage bag within which the enclosure is in contact. The dunnage bag pressure readings can be wirelessly monitored from a remote location and the bag pressure may be controlled remotely.

### CROSS-REFERENCE TO RELATED APPLICATION(S)

The present application claims priority to U.S. Provisional Patent Application No. 62/351,870 filed on Jun. 17, 2016, entitled “DUNNAGE DEVICE AND SYSTEM” the entire disclosure of which is incorporated by reference herein.

### BACKGROUND OF THE INVENTION

### 1. Field of Invention

The present invention relates generally to the field of the measuring of pressure of an inflated device. More specifically, the invention relates to measuring the pressure of a dunnage mechanism during transit.

### 2. Description of Related Art

Dunnage mechanisms are implemented to fill empty spaces, that are created when loading cargo items into a cargo shipment in an enclosed shipping container where the cargo items do not perfectly fit into the cargo container. Dunnage mechanisms are used in all modes of transportation for example road, railway, ocean or air and specific types of mechanism are tailored for specific modes of transporting cargo. As cargo is loaded into a shipping container, there are empty spaces between packages or pallets that must be filled in order to secure the items. Historically the spaces were filled with inexpensive or waste material. More recently, dunnage bags that are air-filled pouches are used to stabilize, secure and protect cargo during transportation.

Typically, dunnage bags are placed in the void spaces that are created between when items of cargo are placed in a vessel or container. These spaces cause the cargo to move around in the vessel during transit and cause damage and breakage of the cargo. Dunnage bags are inflated to a designated pressure enough to fill the empty space between the cargo items so that the inflated dunnage bags act to secure the items within the shipment container by providing a cushioning mechanism between the cargo items and walls of the vessel. The goal is to eliminate and minimize damage and breakage of the cargo that is caused by movement of the container vessel due to movement of the items during the shipment transit.

Currently, there are existing devices that inflate the dunnage bags to a specified inflation pressure and the dunnage bag is sealed. Once sealed, it is assumed that the pressure within the dunnage bag is maintained for the duration of the transit. Monitoring and controlling mechanisms do not exist in present dunnage bags or dunnage mechanisms.

There are a number of shipments where products are lost due to breakage and existing technologies do not effectively provide the necessary dunnage bag pressure data to allow for effective cause analysis of product losses. The present invention aims to solve this problem by optimizing the inflation of the dunnage device in order to reduce damage to cargo during transit.

Based on the foregoing, there is a need in the art for a device and system that allows for the monitoring, data logging, analysis and control of dunnage bag pressure throughout the duration of the shipment.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a plan view of the device, according to an embodiment of the present invention;

FIG. 2 is a side view of the device, according to an embodiment of the present invention;

FIG. 3 is an interactive view of the device, according to an embodiment of the present invention;

FIG. 4 is a circuit view of the device, according to an embodiment of the present invention;

FIG. 5 is a flowchart of the system, according to an embodiment of the present invention.

### DETAILED DESCRIPTION OF PREFERRED EMBODIMENTS

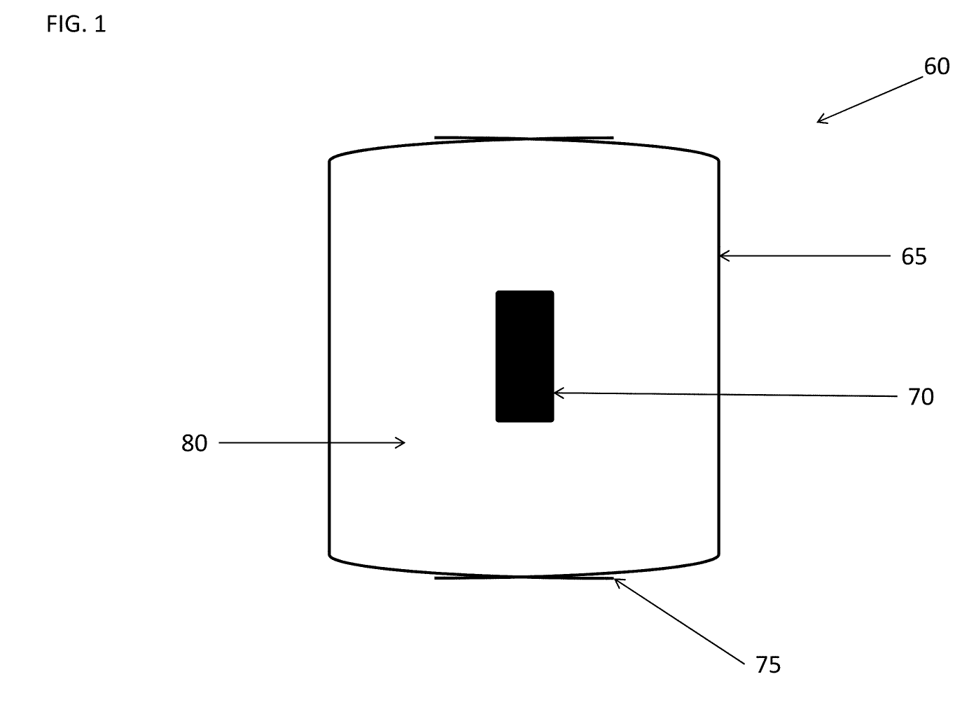

Preferred embodiments of the present invention and their advantages may be understood by referring to FIGS. 1-5, wherein like reference numerals refer to like elements.

In an embodiment, FIG. 1 illustrates a plan view of the device 60 that has a flexible enclosure 65 that is like a bag and/or housing, and sensor module 70 that can be a sensor only and/or a unit with multiple components comprising, for example, a processing unit, transmitter and sensor. In an embodiment, the flexible enclosure is like a bag that is sealed around the edges so that it can be inflated and deflated, and so that when it is an inflated state it maintains the pressure at which it is inflated. In an embodiment, the device/bags are pre-inflated and sealed prior to sending them to customers. In an embodiment, the devices/bags have an inflation port that is compatible with existing dunnage inflation port, such that the same inflation device would fill both the monitoring device and dunnage bag.

In an embodiment the flexible enclosure is made of a uniform flexible material with no seams and the bag is being inflated or deflated via one or more apertures that have valves attached to the apertures too allow for forced entry and exit of air allowing inflation and deflation of the device. In one embodiment the device can be partially inflated, and can be inflated or deflated in varying degrees from zero inflation to a maximum inflation, where at maximum inflation the device can withstand a premeasured amount of pressure, based on the materials and construction method. In another embodiment, the material and/or combination of materials and parts used for construction are changed or adjusted based on the desired maximum pressure required for certain transit activities. For example some transits may require the device to withstand higher pressures and so the device is build of materials and sealed to withstand the higher pressures. In an embodiment, the flexible enclosure is made of different materials with variable flexibility and stiffness to allow for customized implementation, for example the sides 75 of the enclosure may be a stiffer material than the faces 80. In an embodiment, the device is made of multiple enclosures, for example compartments that join at various points, and are attached to each other to form the device.

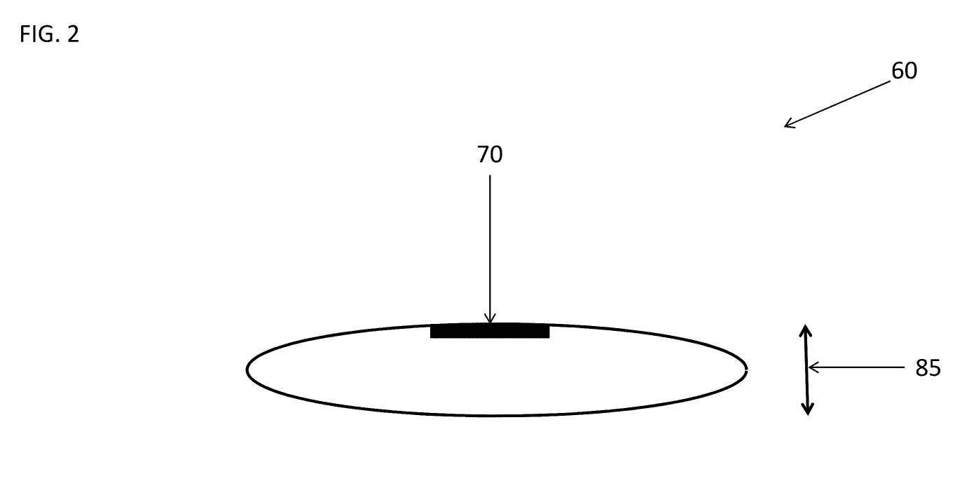

In an embodiment, FIG. 2 illustrates a side view of the device 60 in an inflated state. A user is controlling the degree of inflation 85 and can increase or decrease the level of inflation, depending on the needs of a particular cargo shipment. In a preferred embodiment, the device is inflated to a moderate positive inflation state/pressure before it is placed between cargo items 95 and/or other spaces in the vessel or shipping container. In an embodiment, the sensor or sensor module is attached and/or affixed to the inside 70 of the flexible enclosure 80. In an embodiment, the sensor or sensor module is attached and/or affixed to the outside wall of the flexible enclosure 80. In an embodiment, part of a sensor module can be on the inside the flexible enclosure 80 and part of the sensor module can be on the outside of the flexible enclosure 80.

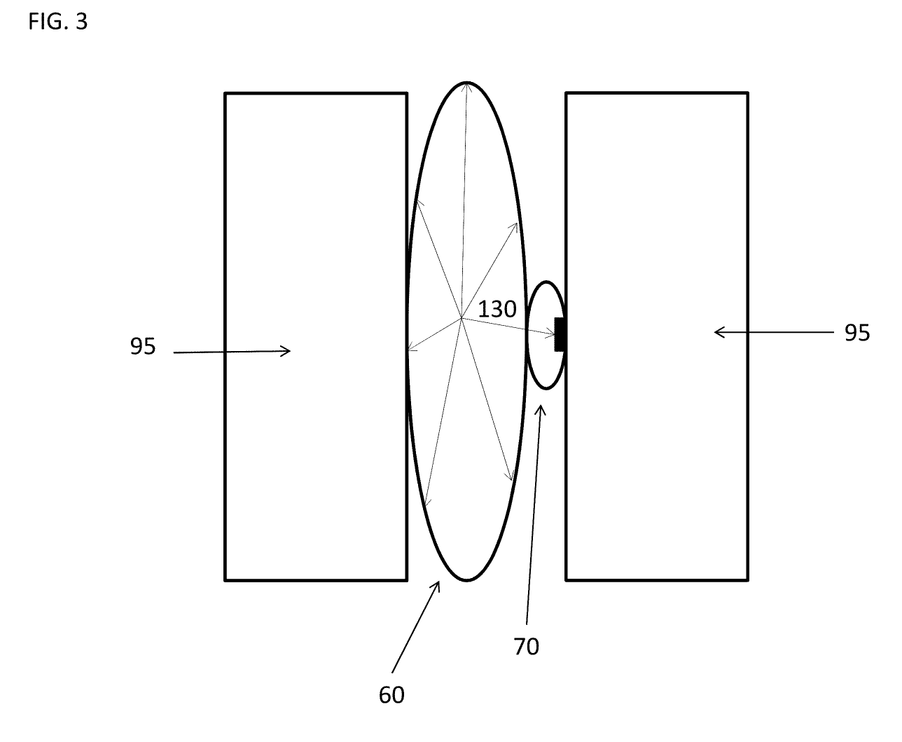

FIG. 3 is a side view of the device 60 and cargo items 95, showing the sensor module 70 affixed to the exterior of the flexible enclosure 65 that is sealed, and the device 60 is in a moderately inflated state placed between the cargo items 95. In an embodiment, the sensor is in a flexible enclosure that is sealed and the enclosure has a positive pressure adjacent to the pressure-monitored unit 60. In an embodiment, a sensor 70 that measures pressure 130 is affixed to the interior of the flexible enclosure 60 and the flexible enclosure is inflated to a slightly positive pressure. The device can be placed anywhere between cargo items and between cargo items and shipment container walls, where there are spaces as a result of loading placements of the cargo items.

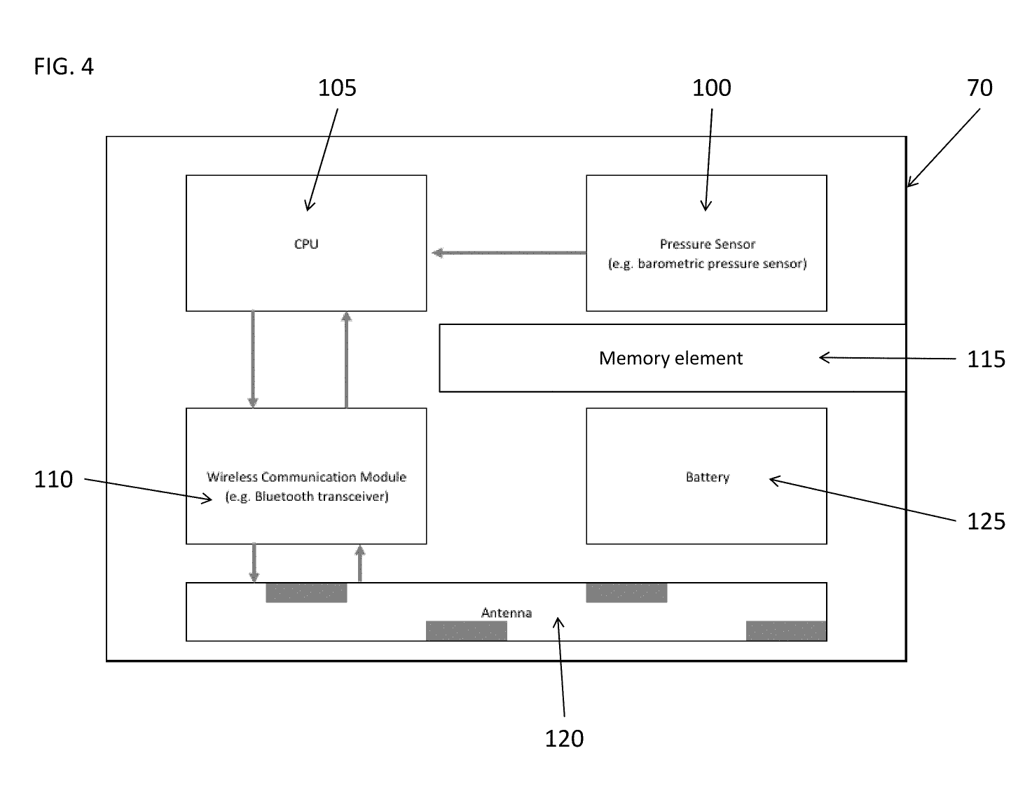

In an embodiment, FIG. 4 a representative view of the sensor module 70 that has a pressure sensor 100, for example a barometric pressure sensor, a central processing unit and/or micro processing unit 105, wireless communication module 110 for example a Bluetooth receiver and transmitter, memory element 115, antenna 120 and battery 125. In an embodiment, other sensors are incorporated into the sensor module 70 and flexible enclosure 65 for example temperature sensors, distance sensors, and light sensors. In a preferred embodiment, the sensor module is attached to the exterior of an existing dunnage bag and can be removed and attached to other dunnage bags. Presently, dunnage bags are often disposed of. Attaching the sensor module to the exterior of a dunnage bag would eventually lead to waste of a sensor. In one embodiment, a detachable sensor module (which can attach and detach from a dunnage bag) can be can be reused with other replacement dunnage devices/bags instead of being disposed.

In an embodiment, a sensor device 100 with the capability of monitoring pressure of the dunnage mechanism or dunnage device 60 is detecting pressure, recording pressure data and logging the data to storage and memory element 115 on the device 60, for example in a CPU register, storage device and external server system. A user is wirelessly retrieving the data from the sensor module 70 utilizing a mobile device, presenting the data on the mobile device and transmitting the sensor data to an internet based reporting platform. The sensor module 70 is placed in a positively inflated, flexible enclosure and the sensor is affixed to one side of the enclosure. The enclosure with the sensor device may be placed in between the dunnage bag 60 and the shipping item 95 to be secured. As pressure 130 is applied within the dunnage bag or device 60 by for example inflating the dunnage device 60, the pressure 130 inside the enclosure 65 achieves a state of equilibrium with the dunnage bag 60 and the sensor 70 within the flexible enclosure and measures the pressure within the enclosure 65, and the measurement is the pressure data for the dunnage bag and device 60. In an additional embodiment, the sensor and enclosure are affixed and/or is an external component of the dunnage bag placed in an area to measure the pressure between the dunnage bag and shipment items. In an additional embodiment, the sensor is placed inside the dunnage bag, where the dunnage bag 60 itself becomes and is also the flexible enclosure.

In an embodiment, the sensor is in a flexible enclosure that is sealed with positive pressure. In an embodiment, the enclosure has a high thermal conductivity such that, if desired, temperatures external to the enclosure can be monitored using the temperature sensor. The enclosure is made of a material and sealed in a manner that can withstand sustained pressure between for example but not limited to 5 and 10 PSI and spike pressures of 20 PSI for instances when for example a sudden significant force is applied to the device 60. This may occur due to external conditions that exert forces on the device 60 during transit by the cargo items and walls of the vessel caused for example by a momentum force.

In an embodiment, the dunnage system has a plurality of dunnage devices 60 with sensor modules 70 that are wirelessly communicating with each other in the system and wirelessly communicating with a remote user and/or external management system. In an embodiment, the sensor modules 70 are sending and receiving signals from each other and recording signals in each of the memory elements 115 in each device, such as a CPU register or other storage device and system that is located within the device and/or externally. In an embodiment, the signals are representing the detected pressure of the devices and any changes in that pressure. The pressure and changes in pressure can be detected and recorded by the system at an instance in time and/or over a period of time specified in the system.

In an embodiment, the available data storage space in the memory element is optimized through a procedure where multiple samples of signals are detected by the sensors and recorded into the memory element. In an embodiment, from the multiple recorded signal samples, the system extracts the minimum, maximum and average values and these values are recorded by the system into the memory element. For example, signal samples may be detected every 5 seconds, but the system will only record and enter the detected signals into the memory element every hour. In this example, the data minimum, maximum and average entered every hour would be comprised of 720 data samples (12 samples per minute times 60 minutes) however would only require the data storage space for the minimum, maximum and average over that period. This provides the advantage of providing very granular data information (samples every 5 seconds) in a significantly reduced memory element utilization compared to continual recording, providing for much longer monitoring durations. In other embodiments, a user is able to remotely alter the intervals and frequency at which the signals are recorded in order to customize for a particular type of transit environment and type of cargo. By way of example, if less monitoring is required due to cargo items being more resilient then the frequency of the recordings can be reduced, if the cargo items are fragile then the frequency can be increased, if the transit is long haul and the memory element has limited storage capacity then the frequency can be decreased. In an embodiment, the device is uploading the signals onto an external storage system and overwrite earlier recorded data in order to maintain capacity in the memory element.

In an embodiment, each device has a unique identification number (ID) that is linked to each device, such that the system is able to recognize each device based on its ID. The system and device can track the location, progress and change in pressure during transit and any other time of each device by extracting data from the CPU register about each device based on the ID. The unique IDs will also allow for a fast count of the number of devices in any given cargo shipment and allow allocation and management of the devices between for example, owners and licensees of the devices. The IDs will also allow a remote user to monitor, control and manipulate the pressure of each device via wireless communication with the processing unit 105 through the unique ID. In an embodiment, the unique ID is based on the MAC address and can be queried using protocols well known in the art.

In an embodiment, the system is collecting data from the devices using a mobile device, for example a mobile phone with the appropriate software application. In an embodiment, a user can (rack, record, manage and control the devices from the mobile phone via the application. In an embodiment, the system detects and records GPS information from the mobile device that is attached to the data at the time of tracking, recording, managing and controlling to record and mark the device/s location. In an embodiment, all data collected by the system at a given point in time, is processed and analyzed to produce a customized report based on the users needs.

In an embodiment, the microprocessors 105 are processing and analyzing the plurality of signals received and detected by the device/s in the system and is generating a map of the signals and pressure systems in the particular vessel, in which the devices are placed. In an embodiment, the data that is collected from these signals and pressure sensors is recorded in a CPU register and is later extracted by the system for monitoring and controlling activities by the remote user.

In an embodiment, the system is mapping and generating an interactive network showing the pressure and inflation level of each device and the affect on adjacent cargo items. In an embodiment, the system is using this map to generate a recommended alteration to the pressure of selected devices in order to return to the optimum security position of the cargo items. In an embodiment, the processing unit is recording time stamps of the transit journey of the device such that the location can be traced and monitored. If the devices are transferred onto another vessel, split up, taken by another user or shipping company, or disposed this is being monitored and communicated to a central user and a chain of custody is being established. The device records the device's real-time clock, real-time reference, in a specified time interval at the time any sample is read by the device. The device transmits data to a wireless mobile device and web-based database where the real-time reference is correlated to the current time and previous time stamps are calculated.

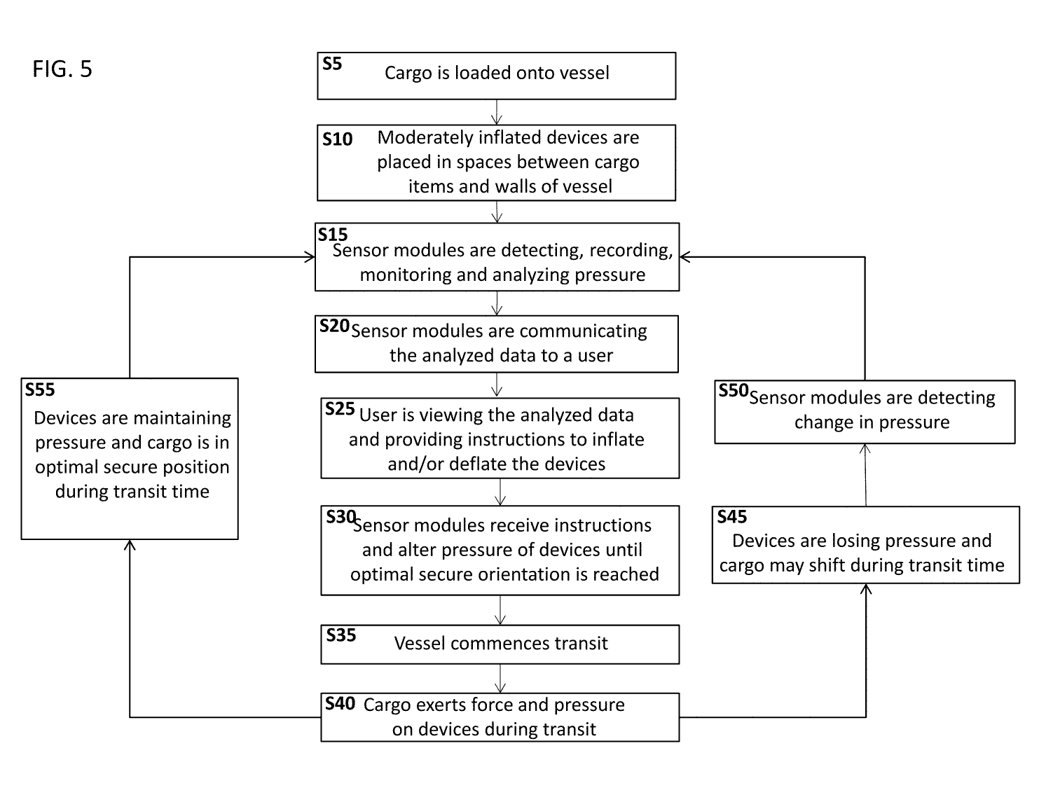

In an embodiment, FIG. 5 is an illustration of the steps involved in the system. At step S 5 the cargo is being loaded onto a vessel, for example a shipment container, ship, airplane, motor vehicle and/or some other vessel used to transport goods. At step S 10, the moderately inflated is placed in the spaces between the cargo items and walls of vessel. In an embodiment, the device is pre-inflated, prior to being placed in a desired space. A desired space can be for example, between two cargo items, between a cargo item and the shipping container wall, in any other configuration that would secure a cargo item within a shipping container. In an embodiment, the device is placed to be in contact with a flat surface of a shipping container or a cargo item. The device can be moved to where there is a regular or irregular space within a shipping container that needs to be filled, for example, between corners, surfaces, edges, and any combinations thereof. The device can be placed anywhere where there is a need to secure the cargo items, for example but not limited to, between walls and the cargo items, ceiling and cargo item, in between the cargo item, and corners of the cargo items and walls. In an embodiment, the device is inflated prior to being placed in a desired space. ‘Securing/secure’ a cargo item has its traditional meaning as known in the art. In an embodiment, ‘securing/secure’ a cargo item means that the device/s acts on the cargo items, either directly by contact and/or indirectly by relayed pressure through adjacent cargo items, to prevent, minimize, and reduce movement of the cargo items during transit or during any movement of the shipping container.

At step S 15, the sensor module is detecting, recording, monitoring and analyzing the pressure exerted by the cargo items and walls, on the device. At step S 20, the sensor module is wirelessly communicating the analyzed data with a user. At step S 25, a user is viewing the analyzed data on a mobile device and deciding if any changes to the pressure in the system are required. The user is providing instructions to inflate and/or the devices. User is instructing to inflate particular devices and deflate other devices based on the analyzed data. For example, one section of the vessel may show to have a reduced pressure and so the user can choose to increase the pressure in that specific section by instructing that the devices in that section be inflated. In an embodiment, the system displays a recommendation of the adjustment that needs to be made in order to return to optimal sure orientation of the cargo in the vessel and the user can accept, reject and modify the recommendation. In this embodiment, a mechanism may be attached to a dunnage bag or enclosure (not shown) which may also be a source of gas pressure to cause inflation thereof by a suitable gas (e.g., air, nitrogen, etc.).

At step S 30, the sensor modules receive instructions and activate to alter the pressure of devices until an optimal secure orientation of the cargo is achieved. At step S 35, when an optimal secure orientation of the cargo is achieved, the vessel commences transit. At step S 40, during the transit journey, the vessel is being exposed to various forces for example but not limited to turbulence, loss/increase of pressure in cabin, ocean conditions, jostling due to rough suspension, and other forces that may shift the cargo items, and exert force and affect the pressure in the devices. When the pressure of the devices is changed, the overall security of the cargo items is compromised.

At step S 45, during the transit time, the devices are losing pressure and the cargo items may be shifting position from their originally secured position that they had been placed in before commencing transit. At step S 50, the sensor modules attached to the devices are detecting any changes in pressure and loops back to step S 15. At step S 55, the devices are maintaining pressure and cargo is in optimal secure position during transit time and the system is in a constant feedback loop until the transit journey is completed.

In some embodiments, the dunnage device and system is providing end-to-end monitoring of dunnage bag 60 pressure during transit of cargo and shipment items and providing real time data for the analysis of damage losses during shipment. In an embodiment, the analysis is applied and mapped to particular cargo item where the placed and loading of those items is known in a vessel and the system can predict whether a particular item may have been damaged during transit. In an embodiment, the owner of the cargo items and or insurance companies may be notified of possible or actual damage in advance to receiving the items.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein and is not limited by plural terms and grammatical variations.

We claim:

1. A gas pressure sensor device for use with a dunnage bag comprising:
a gas pressure sensor;
means for communication between said gas pressure sensor and a remote monitoring station; and
an enclosure to which the gas pressure sensor is attached.

2. The gas pressure sensor device as recited in claim 1 wherein the enclosure is sealed and the gas pressure sensor is within the enclosure.

3. The gas pressure sensor device of claim 1 wherein the means for communication includes a transceiver for communications over a wide area network (WAN).

4. The gas pressure sensor device as recited in claim 1 further including an identification number for dispatch, by said means for communication, to said remote monitoring station.

5. The gas pressure sensor device as recited in claim 1 wherein the enclosure is a dunnage bag.

6. The gas pressure sensor device as recited in claim 1 further including means, attached to the enclosure, to change the pressure of the enclosure.

7. The gas pressure sensor device of claim 6 wherein said means, attached to the enclosure, to change the pressure of the enclosure is capable of increasing the pressure of the enclosure.

8. The gas pressure sensor device of claim 1 wherein the sensor is detachably affixed to the enclosure.

9. The gas pressure sensor device as recited in claim 8 wherein the enclosure is a dunnage bag.

10. A method for determining potential damage to cargo based on detection of a damaged dunnage bag, comprising:
measuring gas pressure of the dunnage bag using a sensor and wirelessly dispatching readings of the gas pressure to a remote location.

11. The method as recited in claim 11 wherein measuring the gas pressure of the dunnage bag is accomplished by measuring the gas pressure of a sealed enclosure, including a gas pressure sensor, adjacent at least one cargo item and wedged between the cargo item and a second item.

12. The method as recited in claim 11 wherein the second item is selected from objects consisting of a wall of a shipping container, a second cargo item, a fixture within the shipping container and combinations thereof.

13. The method as recited in claim 10 which further includes
dispatching signals relaying an identification number corresponding to the sensor along with information indicative of pressure readings in the dunnage bag.

14. The method as recited in claim 13 wherein dispatching signals re-occurs at predetermined intervals.

15. The method as recited in claim 10 wherein the signals also contain geographical positioning information corresponding to the location of the sensor.

16. A method of monitoring dunnage bag pressure, comprising:
wirelessly receiving pressure data from a sensor measuring dunnage bag pressure.

17. The method as recited in claim 16, wherein the sensor is measuring dunnage bag pressure by measuring the gas pressure of a sealed enclosure, including a gas pressure sensor, adjacent at least one cargo item and wedged between the at least one cargo item and a second item.

18. The method of claim 16 further including wirelessly transmitting inflate or deflate instructions to a gas pressure sensor device.

19. The method of claim 18 wherein the instructions cause a dunnage bag to inflate or deflate based on gas pressure information received.

20. The method of claim 16 further comprising recording the pressure data.

21. The method as recited in claim 20 wherein the data pressure readings are received according to a first frequency and the data pressure readings are recorded according to a second frequency.

22. The method as recited in claim 21 wherein the first frequency or second frequency are alterable from a remote location away from the location of the dunnage bag.
